(19) United States
(12) Patent Application Publication
(10) Pub. No.: US 2012/0114544 A1
(43) Pub. Date: May 10, 2012

(54) ORGANIC CHLOROHYDROSILANE AND METHOD FOR PREPARING THEM

(75) Inventors: Il Nam Jung, Yongin-si (KR); Soon Hyun Hong, Gwangju-si (KR); Eun Seong Kim, Seongnam-si (KR); Sang Il Hyun, Seoul (KR)

(73) Assignee: SAMSUNG FINE CHEMICALS CO., LTD, Ulsan (KR)

(21) Appl. No.: 13/383,697

(22) PCT Filed: Jul. 13, 2010
(86) PCT No.: PCT/KR2010/004548

§ 371 Date: Jan. 12, 2012

(30) Foreign Application Priority Data
Jul. 13, 2009 (KR) 10-2009-0063616

(51) Int. Cl. C01B 33/107; C07F 7/10; C07F 7/08

(52) U.S. Cl. 423/342; 556/469; 556/465; 546/14; 556/489

(57) ABSTRACT

Provided is an organic chlorohydrosilane, a useful starting material for preparing silicon polymers and a method for preparing the same. More particularly, the present invention enables the synthesis of various novel organic chlorohydrosilanes in high yield by an exchange reaction between an Si—H bond of a chlorosilane which can be obtained in an inexpensive and easy manner and an Si—Cl bond of an another organic chlorosilane using a quaternary organic phosphonium salt compound as a catalyst. Since the catalyst can be recovered after its use and reused, the present invention is very economical and thus effective for mass-producing silicon raw materials.

### CROSS REFERENCE TO RELATED APPLICATIONS

This application is the U.S. national phase application of International Patent Application No. PCT/KR2010/004548 filed on Jul. 13, 2010, which claims priority of Korean Application No. 10-2009-0063616 filed on Jul. 13, 2009, the entire contents of all of the above applications are hereby incorporated by reference into the present application.

### TECHNICAL FIELD

This patent application claims the benefit of priority from Korean Patent application No. 10-2009-0063616, filed on Jul. 13, 2009 in the Korean Intellectual Property Office (KIPO), the contents of which are incorporated herein by reference.

The present invention relates to an organic chlorohydrosilane and a method for preparing the same, and more particularly, to a method for synthesizing various novel organic chlorohydrosilanes in high yield by an exchange reaction between an Si—H bond of a chlorosilane and an Si—Cl bond of an another organic chlorosilane using a quaternary organic phosphonium salt compound as a catalyst.

### BACKGROUND ART

Recently, the present inventors have reported a method in which an alkyl chloride having a C—Cl bond and a trichlorosilane (HSiCl3) having an Si—H bond were reacted using a tetraalkylphosphonium chloride compound as a catalyst to form a silicon-carbon (Si—C) bond, while removing hydrogen chloride upon producing it by detaching chlorine from the alkyl chloride and hydrogen from the trichlorosilane (HSiCl3), to thus synthesize various organic silicon compounds (Y. S. Cho; S-H. Kang; J. S. Han; B. R. Yoo; II Nam Jung; J. Am. Chem. Soc., 123, 2001, 5583; I. N. Jung et al, U.S. Pat. No. 6,392,077). This dehydrochlorination is a novel method for forming a silicon-carbon bond, which is very useful for synthesizing various novel organic silicon compounds.

Organic chlorides like trichlorosilanes used for the dehydrochlorination can be reacted with alkyl chlorides that do not have a strong activity, cyclic alkyl chlorides, and tertiary alkyl chlorides, as well as alkyl chlorides in which a chlorine is bonded to a carbon having a strong activity, such as benzyl chloride or allyl chloride, to thus synthesize organic silicon compounds in high yield.

In the Korean Patent Number 10-0487904 (Apr. 27, 2005), the present inventors have disclosed that when ketones or aldehydes are reacted with a trichlorosilane (HSiCl3) using a tetraalkylphosphonium chloride compound catalyst, organic trichlorosilanes in which trichlorosilane is introduced into the site of oxygen are obtained.

In addition, the present inventors have disclosed in the Korean Patent Number 10-0491960 (May 30, 2005) that when alkenes are reacted with a trichlorosilane using a quaternary organic phosphonium salt as a catalyst, bissilylalkane compounds into which two silyl groups are introduced to the carbon-carbon double bond through silylation can be synthesized in high yield.

In this way, the method using a tetraalkylphosphonium chloride compound catalyst can prepare silane compounds having various organic groups and thus has enabled the manufacture of new products through the supply of new raw materials for the silicone industry or the manufacture of various products through the modification of existing products.

However, there are limitations that silane compounds prepared in this way have trichlorosilyl groups at one side or both sides of a molecule and have multiple Si—Cl bonds in one molecule, and are not suitable for manufacturing silicone oil or rubber which are most commonly used in the silicone market. Namely, raw materials which can be used for manufacturing silicone oil or rubber need to have two organic groups and two Si—Cl bonds in one silicon atom. Therefore, the exchange reaction of an Si—Cl bond for an Si—H bond can reduce the number of Si—Cl bonds and an Si—H bond can be added to organic groups having a double bond or a triple bond through hydrosilylation and it enables the preparation of raw materials having various organic groups. Therefore, the exchange reaction of an Si—Cl bond for an Si—H bond is very significant.

Meanwhile, in the exchange reaction of an Si—Cl bond and an Si—H bond, Lewis acids such as aluminum chloride and boron chloride are known to have a catalytic effect for the redistribution reaction of chlorosilanes. Organic compounds such as tertiary amines, quaternary ammonium chlorides, nitrile compounds, and organic phosphine compounds, are known to play a role as a catalyst in the following reactions of the redistribution of trichlorosilane (HSiCl3) to dichlorosilane and the preparation of mono(chloro)silane.

Union Carbide Corporation in the U.S. have reported that Amberyst (manufactured by Rohm and Haas company in the U.S.) in which amines or ammonium salts are immobilized on an ion exchange resin is a good catalyst in this reaction. With this, a matter of separating reaction products from catalysts after reaction was solved.

However, Amberyst immobilized on an ion exchange resin has several disadvantages. Since it is a porous resin, it absorbs moisture and is susceptible to swelling. In addition, it is degraded easily under acidic conditions because amines or ammonium salts are substituted at the benzyl sites. Therefore, the present inventors have developed a new immobilized catalyst by substituting amines or ammonium salts on a silicone resin and disclosed it in the U.S. Pat. No. 4,613,491 and U.S. Pat. No. 4,701,430.

However, among the exchange reactions of Si—H bonds and Si—Cl bonds, few reactions which can be applied to organic chlorohydrosilanes which are substituted with alkyl groups have been reported. In 1947, Whitmore and his colleagues reported the reaction for the first time (F. C. Whitmore; E. W. Pietrusza; L. H. Sommer, J. Am. Chem. Soc., 69, 1947, 2108). The catalyst used for the following reaction was aluminum chloride (AlCl₃).

In 1957, Dolgov and his colleagues in Russia reported that they redistributed ethyldichlorosilane into ethylchlorosilane and ethyltrichlorosilane in the presence of aluminum chloride catalyst (B. N. Dolgov; S. N. Borisov; M. G. Voronkov, Zhur. Obschei. Khim., 27, 1957, 2062). However, since the redistribution reaction using aluminum chloride as a catalyst requires the reaction temperatures as high as 150 to 400° C., it lacks practicality.

Bailey and Wagner reported that they redistributed ethyldichlorosilanes or phenyldichlorosilanes using adiponitrile as a catalyst at the temperature of 150 to 200° C. (D. L. Bailey and G. H. Wagner).

### DISCLOSURE

### Technical Problem

The present inventors intend to solve the limitations of the related art for preparing an organic chlorohydrosilane, a useful starting material for manufacturing a variety of silicone oil or rubber.

### Technical Solution

Therefore, the present inventors used a quaternary organic phosphonium salt compound which has never been used for a catalyst and inexpensive chlorosilanes having an Si—H bond and exchanged one or two Si—Cl bonds among three Si—Cl bonds in organic trichlorosilanes for Si—H bond(s), thereby preparing organic chlorohydrosilanes in high yield in which both an Si—Cl bond which can be hydrolyzed and then polymerized and an Si—Cl bond which can react with a unsaturated organic compound through hydrosilylation so as to incorporate a new organic group are included within one molecule.

Therefore, the present invention is to provide an organic chlorohydrosilane which has both an Si—Cl bond and an Si—H bond within one molecule.

The present invention is also to provide a method for preparing the organic chlorohydrosilane.

### Advantageous Effects

The present invention can synthesize a new organic chlorohydrosilane in high yield which includes both an Si—H bond and an Si—Cl bond by using a quaternary organic phosphonium salt as a catalyst. Since the catalyst can be recovered after its use and reused, the present invention is very economical and thus effective for mass-producing silicon raw materials. In addition, since using the catalyst enables the reaction at a comparatively low temperature ranging from room temperature to about 200° C. or lower, the present invention is economical.

### BEST MODE

The present invention provides an organic chlorohydrosilane which may be represented by Chemical Formula 1 shown below:

R³—SiHₐCl₍₃₋ₐ₎ [Chemical Formula 1]

In Chemical Formula 1, a is 1 or 2 and R3 represents as defined below.

The present invention also provides a method for preparing an organic chlorohydrosilane which may comprise reacting a silane compound represented by Chemical Formula 2 shown below and an organic chlorosilane represented by Chemical Formula 3 shown below in the presence of a quaternary phosphonium salt catalyst.

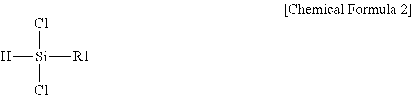

In Chemical Formula 2, R1 represents as defined below.

R²—SiCl₃. [Chemical Formula 3]

In Chemical Formula 3, R2 represents as defined below.

The present invention will now be described in detail as follows.

Organic chlorohydrosilanes according to the present invention may be represented by Chemical Formula 1 shown below and can be obtained by reacting a silane compound represented by Chemical Formula 2 shown below and an organic chlorosilane represented by Chemical Formula 3 shown below in the presence of a quaternary phosphonium salt catalyst.

R³—SiHₐCl₍₃₋ₐ₎ [Chemical Formula 1]

In Chemical Formula 1, a is 1 or 2,

when a is 1, R³ represents chlorine, a linear alkyl group having 2 to 18 carbons, isopropyl, isobutyl, cyclopentyl, cyclohexyl, neopentyl, 2-ethylhexyl, iso-octyl, cycloheptyl, cyclooctyl, cyclohexenylmethyl, 9-anthrathenyl, 9-anthrathenylmethyl, 2-(2-pyridyl)ethyl, 2-(4-pyridyl)ethyl, CF₃CH₂CH₂, diphenylmethyl, 2-(bicycloheptyl), 5-[(bicycloheptenyl)ethyl], 11-acetoxyundecyl, 11-chloroundecyl, phenyl, benzyl, 2-phenylethyl, 1-naphthyl, CH₃(C═O)O(CH₂)_{K} (here, k is 2, 3, 10), R⁴-Ph-(CH₂)ₗ (here, l is 0, 1, 2, 3 and R⁴ is an alkyl group having 1 to 4 carbons or a halogen atom), Cl—(CH₂)ₘ (here, m is an integer of 1 to 12), NC—(CH₂)ₙ (here, n is an integer of 2 to 11), CH₂═CH—(CH₂)ₒ (here, o is an integer of 0 to 20), Ar¹-CH(Me)—CH₂ (here, Ar¹ is an alkyl group having 1 to 4 carbons, phenyl substituted with a halogen atom, biphenyl, biphenyl ether, or naphthyl), Ar²O—(CH₂)ₚ (here, p is an integer of 3 to 18 and Ar² is phenyl, biphenyl, biphenyl ether, naphthyl, or phenanthryl), Cl₃Si—(CH₂)_{q} (here, q is an integer of 0 to 12 and Cl₃Si may be Cl₂HSi), Cl₃Si—(CH₂)ᵣ—Ar³—(CH₂)ᵣ (here, r is 0 or 1, Ar³ is phenyl, biphenyl, naphthyl, or anthrathenyl, and Cl₃Si may be Cl₂HSi), or 2,2,5,5-tetrachloro-4-trichlorosilyl-2,5-disilylcyclohexyl (here, Cl₃Si may be Cl₂HSi); and

when a is 2, R³ is chlorine, a linear alkyl group having 2 to 18 carbons, isopropyl, isobutyl, 2-ethylhexyl, cyclopentyl, cyclohexyl, 2-(bicycloheptyl), neopentyl, iso-octyl, cycloheptyl, cyclooctyl, cyclohexenylmethyl, 2-(2-pyridyl)ethyl, 2-(4-pyridyl)ethyl, 5-[(bicycloheptenyl)ethyl], 11-acetoxyundecyl, 11-chloroundecyl, phenyl, benzyl, 2-phenylethyl, 1-naphthyl, naphthylmethyl, diphenylmethyl, CH₃(C═O)O(CH₂)_{K} (here, k is 2, 3, 10), R⁴-Ph-(CH₂)ₗ (here, l is 0, 1, 2, 3 and R⁴ is an alkyl group having 1 to 4 carbons or a halogen atom), Cl—(CH₂)ₘ (here, m is an integer of 1 to 12), NC—(CH₂)ₘ (here, m is an integer of 2 to 11), CH₂═CH—(CH₂)ₒ (here, o is an integer of 0 to 20), Ar¹-CH(Me)—CH, (here, Ar¹ is an alkyl group having 1 to 4 carbons, phenyl substituted with a halogen atom, biphenyl, biphenyl ether, or naphthyl), Ar²O—(CH₂)ₚ (here, p is an integer of 3 to 18 and Ar² is phenyl, biphenyl, biphenyl ether, naphthyl, or phenanthryl), or Ar⁴—(CH₂)_{q}-(here, q is 0 or 1 and Ar⁴ is biphenyl or anthrathenyl).

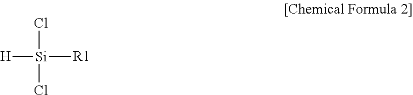

In Chemical Formula 2, R¹ is chorine, methyl, trichlorosilylmethyl, dichlorosilylmethyl, or methyldichlorosilylmethyl.

R²—SiCl₃. [Chemical Formula 3]

In Chemical Formula 3, R² is chlorine, a linear alkyl group having 2 to 18 carbons, isopropyl, isobutyl, tertiary-butyl, neopentyl, iso-octyl, cyclopentyl, cyclohexyl, cycloheptyl, cyclooctyl, cyclohexenylmethyl, 2-(2-pyridyl)ethyl, 2-(4-pyridyl)ethyl, 2-(bicycloheptyl), 5-[(bicycloheptenyl)ethyl], 5-(bicycloheptenyl), 11-acetoxyundecyl, 11-chloroundecyl, phenyl, benzyl, 2-phenylethyl, 1-naphthyl, diphenylmethyl, CH₃(C═O)O(CH₂)_{K} (here, k is 2, 3, 10), CF₃(CF₂)ₗCH₂CH₂ (here, l is an integer of 0 to 12), R⁴-Ph-(CH₂)ₘ (here, m is 0, 1, 2, 3 and R⁴ is an alkyl group having 1 to 4 carbons or a halogen atom), Cl—(CH₂)ₙ— (here, n is an integer of 1 to 12), NC—(CH₂)ₒ— (here, o is an integer of 2 to 11), CH₂═CH—(CH₂)ₚ— (here, p is an integer of 0 to 20), Ar¹-CH(Me)—CH₂— (here, Ar¹ is an alkyl group having 1 to 4 carbons, phenyl substituted with a halogen atom, biphenyl, biphenyl ether, or naphthyl), Ar²O—(CH₂)_{q}— (here, q is an integer of 3 to 18 and Ar² is phenyl, biphenyl, biphenyl ether, naphthyl, or phenanthryl), Cl₃Si—(CH₂)ᵣ (here, r is an integer of 0 to 12), Cl₃Si—(CH₂)ₛ—Ar³—(CH₂)ₛ (here, s is 0 or 1, Ar³ is phenyl, biphenyl, naphthyl, anthrathenyl, or 2,2,5,5-tetrachloro-4-trichlorosilyl-2,5-disilylcyclohexyl), or Ar⁴—(CH₂)ₜ— (here, t is 0 or 1 and Ar⁴ is phenyl, biphenyl, naphthyl, or anthrathenyl), trichlorosilyl (Cl₃Si—) or trichlorosilyloxy (Cl₃SiO).

Specific examples of silane compound represented by Chemical Formula 2 may be one or more selected from the group consisting of methyldichlorosilane, (dichlorosilylmethyl)dichlorosilane, (trichlorosilylmethyl)dichlorosilane, and (methyldichlorosilylmethyl)dichlorosilane.

In addition, a quaternary organic phosphonium salt, a catalyst used for preparing the organic chlorohydrosilane of the present invention may be represented by Chemical Formulas 4 or 5 shown below:

X(R⁵)₄P [Chemical Formula 4]

X(R⁵)₃P—Y—P(R⁵)₃X [Chemical Formula 5]

In Chemical Formulas 4 and 5, X indicates a halogen atom, R⁵, which is the same or different, indicates an alkyl group having 1 to 12 carbons or —(CH₂)ᵤ—C₆H₅ (here, u is an integer of 0 to 6), two R⁵s can be covalently bonded to form 4-atom rings or 8-atom rings, and Y is an alkylene group having 1 to 12 carbons.

Preferably, the quaternary organic phosphonium salt catalyst is used within the range of from about 0.05 mol to about 0.5 mol with respect to 1 mol of organic chlorosilane represented by Chemical Formula 3.

In addition, the quaternary organic phosphonium salt compound represented by Chemical Formula 4 or 5 may be directly used or immobilized on one or more carriers selected from the group consisting of a silicone resin, silica, an inorganic complexing agent, and an organic polymer and then used for the quaternary organic phosphonium salt catalyst according to the present invention. For example, the silicone resin has a structure including phosphonium salts which have a catalytic activity for the silicone resin, like the structure of (Cl—Bu3P+(CH2)3-SiO3/2)n, and the other carriers also have a similar structure in which phosphonium salts having a catalytic activity are immobilized in the carriers. The technique of immobilizing the catalyst in various carriers is not particularly limited but follows the general catalyst immobilization method, and a detailed description thereof will be omitted.

Further, the reaction according to the present invention is performed within a temperature range of from about 20 to about 200° C. and it is preferable to perform the reaction within a temperature range of from about 50 to about 100° C. Also, preferably, the reaction is performed without a reaction solvent, and selectively, it may be performed as necessary in the presence of one or more aromatic hydrocarbon solvents selected from the group consisting of benzene, toluene, and xylene.

Meanwhile, in the present invention, the silane compound having an Si—H bond represented by Chemical Formula 2 is reacted within the range of from about 1 to about 20 mol, preferably from about 1 to about 6 mol with respect to 1 mol of the organic chlorosilane represented by Chemical Formula 3.

The reaction for preparing the organic chlorohydrosilane of the present invention is preferably performed in a batch process or a continuous process.

The following examples will specify the present invention, but the scope of the present invention is not limited thereto.

### Example 1

### Reaction of Tetrachlorosilane and Methyldichlorosilane in the Presence of Tetrabutylphosphonium Chloride Catalyst

A reaction vessel formed as a 25 ml stainless steel tube dried in an oven was cooled in the presence of dried nitrogen gas, in which 2.5 g (0.015 mol) of tetrachlorosilane, 9.7 g (0.090 mol) of methyldichlorosilane, and 0.4 g (0.0015 mol) of tetrabutylphosphonium chloride were then put. The entrance of the reaction vessel was hermetically sealed with a stopper, reaction was performed at 80° C. for three hours, and then, consumption of starting materials and products were checked through a gas chromatography. 1.5 g (yield: 73.3%) of trichlorosilane and 0.2 g (yield: 2.2%) of dichlorosilane were obtained through atmospheric distillation of reactants.

The results of analyzing the obtained products by using 300 MHz 1H magnetic resonance showed that, in trichlorosilane, Si—H peak was confirmed at δ6.15 ppm (s, 1H), and in dichlorosilane, Si—H peak was confirmed at δ5.37 ppm (s, 2H).

### Example 2

### Reaction of Hexyltrichlorosilane and Methyldichlorosilane in the Presence of Tetrabutylphosphonium Chloride Catalyst

In the same manner as Example 1, 3.0 g (0.014 mol) of hexyltrichlorosilane, 9.7 g (0.084 mol) of methyldichlorosilane, and 0.4 g (0.0014 mol) of tetrabutylphosphonium chloride were put in a 25 ml stainless steel tube and reacted at 80° C. for three hours. The reactants were atmospheric-distilled to obtain 1.9 g (yield: 73.3%) of hexyldichlorosilane and 0.2 g (yield: 9.5%) of hexylchlorosilane were obtained.

The results of analyzing the obtained products by using 300 MHz 1H magnetic resonance showed that, in hexyldichlorosilane, Si—H peak was confirmed at δ5.51 ppm (t, 1H), —CH₂— peak was confirmed at δ1.17-1.56 ppm (m, 10H), and —CH₂—CH₃ peak was confirmed at δ0.89 ppm (t, 3H). In hexylchlorosilane, Si—H peak was confirmed at δ5.14 ppm (t, 2H), —CH₂— peak was confirmed at δ1.13-1.46 ppm (m, 10H), and —CH₂—CH₃ peak was confirmed at δ0.93 ppm (t, 3H).

### Example 3

### Reaction of Octadecyltrichlorosilane and Methyldichlorosilane in the Presence of Tetrabutylphosphonium Chloride Catalyst

In the same manner as Example 1, 5.0 g (0.013 mol) of octadecyltrichlorosilane, 9.0 g (0.078 mol) of methyldichlorosilane, and 0.4 g (0.0013 mol) of tetrabutylphosphonium chloride were put in a 25 ml stainless steel tube and reacted at 80° C. for three hours. The reactants were vacuum-distilled to obtain 3.0 g (yield: 61.5%) of octadecyldichlorosilane and 0.4 g (yield: 9.6%) of octadecylchlorosilane were obtained.

The results of analyzing the obtained products by using 300 MHz 1H magnetic resonance showed that, in octadecyldichlorosilane, Si—H peak was confirmed at δ5.38 ppm (t 1H), —CH₂— peak was confirmed at δ1.18-1.53 ppm (m, 34H), and —CH₂—CH₃ peak was confirmed at δ0.93 ppm (t, 3H). In octadecylchlorosilane, Si—H peak was confirmed at δ4.88 ppm (t, 2H), —CH₂— peak was confirmed at δ1.12-1.55 ppm (m, 34H), and —CH₂—CH₃ peak was confirmed at δ0.94 ppm (t, 3H).

### Example 4

### Reaction of Octadecyltrichlorosilane and Methyldichlorosilane in the Presence of Tetrabutylphosphonium Chloride Catalyst

In the same manner as Example 1, 2.0 g (0.005 mol) of octadecyltrichlorosilane, 6.9 g (0.060 mol) of methyldichlorosilane, and 0.2 g (0.0005 mol) of tetrabutylphosphonium chloride were put in a 25 ml stainless steel tube and reacted at 80° C. for three hours. The reactants were vacuum-distilled to obtain 1.1 g (yield: 69.0%) of octadecylchlorosilane and 0.2 g (yield: 11.3%) of octadecyldichlorosilane were obtained. Peak confirmation of each product is the same as Example 3 above.

### Example 5

### Reaction of Isopropyltrichlorosilane and Methyldichlorosilane in the Presence of Tetrabutylphosphonium Chloride Catalyst

In the same manner as Example 1, 2.5 g (0.014 mol) of isopropyltrichlorosilane, 9.7 g (0.085 mol) of methyldichlorosilane, and 0.4 g (0.0014 mol) of tetrabutylphosphonium chloride were put in a 25 ml stainless steel tube and reacted at 80° C. for three hours. The reactants were atmospheric-distilled to obtain 1.6 g (yield: 79.9%) of isopropyldichlorosilane and 0.1 g (yield: 6.6%) of isopropylchlorosilane were obtained.

The results of analyzing the obtained products by using 300 MHz 1H magnetic resonance showed that, in isopropyldichlorosilane, Si—H peak was confirmed at 55.39 ppm (s, 1H), CH₃—CH—Si peak was confirmed at δ1.37 ppm (m, 1H), and CH₃—CH peak was confirmed at δ1.16 ppm (d, 6H). In isopropylchlorosilane, Si—H peak was confirmed at δ5.21 ppm (s, 2H), CH₃—CH—Si peak was confirmed at δ1.13 ppm (m, 1H), and CH₃—CH peak was confirmed at δ1.16 ppm (d, 6H).

### Example 6

### Reaction of Isobutyltrichlorosilane and Methyldichlorosilane in the Presence of Tetrabutylphosphonium Chloride Catalyst

In the same manner as Example 1, 2.0 g (0.010 mol) of isobutyltrichlorosilane, 6.9 g (0.060 mol) of methyldichlorosilane, and 0.3 g (0.0010 mol) of tetrabutylphosphonium chloride were put in a 25 ml stainless steel tube and reacted at 80° C. for three hours. The reactants were atmospheric-distilled to obtain 1.2 g (yield: 76.3%) of isobutyldichlorosilane and 0.2 g (yield: 16.3%) of isobutylchlorosilane were obtained.

The results of analyzing the obtained products by using 300 MHz 1H magnetic resonance showed that, in isobutyldichlorosilane, Si—H peak was confirmed at δ5.37 ppm (s, 1H), CH₃—CH—CH₂ peak was confirmed at δ1.54-1.62 ppm (m, 1H), CH—CH₂—Si peak was confirmed at 81.32 ppm (t, 2H), and CH—CH₃ peak was confirmed at δ1.14 ppm (d, 6H). In isobutylchlorosilane, Si—H peak was confirmed at δ5.13 ppm (s, 2H), CH₃—CH—CH₂ peak was confirmed at δ1.53-1.67 ppm (m, 1H), CH—CH₂—Si peak was confirmed at δ1.32 ppm (t, 2H), and CH—CH₃ peak was confirmed at δ1.19 ppm (d, 6H).

### Example 7

### Reaction of Isobutyltrichlorosilane and Methyldichlorosilane in the Presence of Tetraethylphosphonium Chloride 182.67 Catalyst

In the same manner as Example 1, 2.0 g (0.010 mol) of isobutyltrichlorosilane, 6.9 g (0.060 mol) of methyldichlorosilane, and 0.2 g (0.0010 mol) of tetraethylphosphonium chloride were put in a 25 ml stainless steel tube and reacted at 80° C. for three hours. The reactants were vacuum-distilled to obtain 1.1 g (yield: 70.0%) of isobutyldichlorosilane and 0.2 g (yield: 16.3%) of isobutylchlorosilane were obtained. Peak confirmation of each product is the same as Example 6 above.

### Example 8

### Reaction of Neopentyltrichlorosilane and Methyldichlorosilane in the Presence of Tetrabutylphosphonium Chloride Catalyst

In the same manner as Example 1, 2.5 g (0.012 mol) of neopentyltrichlorosilane, 8.4 g (0.073 mol) of methyldichlorosilane, and 0.4 g (0.0012 mol) of tetrabutylphosphonium chloride were put in a 25 ml stainless steel tube and reacted at 80° C. for three hours. The reactants were vacuum-distilled to obtain 1.7 g (yield: 81.4%) of neopentyldichlorosilane and 0.2 g (yield: 12.2%) of neopentylchlorosilane were obtained.

The results of analyzing the obtained products by using 300 MHz 1H magnetic resonance showed that, in neopentyldichlorosilane, Si—H peak was confirmed at 85.65 ppm (t, 1H), C—CH₂—Si peak was confirmed at δ1.39 ppm (d, 2H), and C—CH₃ peak was confirmed at δ1.12 ppm (s, 9H). In neopentylchlorosilane, Si—H peak was confirmed at δ5.23 ppm (t, 2H), C—CH₂—Si peak was confirmed at δ1.41 ppm (t, 2H), and C—CH₃ peak was confirmed at δ1.12 ppm (s, 9H).

### Example 9

### Reaction of 2-Ethylhexyltrichlorosilane and Methyldichlorosilane in the Presence of Tetrabutylphosphonium Chloride Catalyst

In the same manner as Example 1, 3.5 g (0.014 mol) of 2-ethylhexyltrichlorosilane, 9.7 g (0.084 mol) of methyldichlorosilane, and 0.4 g (0.0014 mol) of tetrabutylphosphonium chloride were put in a 25 ml stainless steel tube and reacted at 80° C. for three hours. The reactants were vacuum-distilled to obtain 2.2 g (yield: 73.7%) of 2-ethylhexyldichlorosilane and 0.4 g (yield: 16.0%) of 2-ethylhexylchlorosilane were obtained.

The results of analyzing the obtained products by using 300 MHz 1H magnetic resonance showed that, in 2-ethylhexyldichlorosilane, Si—H peak was confirmed at 85.88 ppm (t, 1H), —CH— peak was confirmed at δ1.56 ppm (m, 1H), —CH₂— peak was confirmed at δ1.23-1.35 ppm (m, 10H), and —CH₃— peak was confirmed at δ0.96-1.10 ppm (m, 6H). In 2-ethylhexylchlorosilane, Si—H peak was confirmed at δ5.32 ppm (t, 2H), —CH— peak was confirmed at δ1.49 ppm (m, 1H), —CH₂— peak was confirmed at δ1.26-1.35 ppm (m, 10H), and —CH₃— peak was confirmed at δ0.92-1.14 ppm (m, 6H).

### Example 10

### Reaction of Cyclopentyl trichlorosilane and Methyldichlorosilane in the Presence of Tetrabutylphosphonium Chloride Catalyst

In the same manner as Example 1, 2.5 g (0.012 mol) of cyclopentyl trichlorosilane, 8.5 g (0.074 mol) of methyldichlorosilane, and 0.4 g (0.0012 mol) of tetrabutylphosphonium chloride were put in a 25 ml stainless steel tube and reacted at 80° C. for three hours. The reactants were vacuum-distilled to obtain 1.7 g (yield: 81.7%) of cyclopentyl dichlorosilane and 0.2 g (yield: 12.4%) of cyclopentyl chlorosilane were obtained.

The results of analyzing the obtained products by using 300 MHz 1H magnetic resonance showed that, in cyclopentyl dichlorosilane, Si—H peak was confirmed at δ5.43 ppm (s, 2H), and cyclopentyl-H peak was confirmed at δ1.47-1.93 ppm (m, 9H). In cyclopentyl chlorosilane, Si—H peak was confirmed at δ5.17 ppm (s, 2H), and cyclopentyl-H peak was confirmed at δ1.44-1.94 ppm (m, 9H).

### Example 11

### Reaction of Cyclohexyl trichlorosilane and Methyldichlorosilane in the Presence of Tetrabutylphosphonium Chloride Catalyst

In the same manner as Example 1, 2.5 g (0.011 mol) of cyclohexyl trichlorosilane, 7.6 g (0.066 mol) of methyldichlorosilane, and 0.3 g (0.0011 mol) of tetrabutylphosphonium chloride were put in a 25 ml stainless steel tube and reacted at 120° C. for three hours. The reactants were vacuum-distilled to obtain 1.5 g (yield: 74.4%) of cyclohexyl dichlorosilane and 0.1 g (yield: 6.1%) of cyclohexyl chlorosilane were obtained.

The results of analyzing the obtained products by using 300 MHz 1H magnetic resonance showed that, in cyclohexyl dichlorosilane, Si—H peak was confirmed at δ5.39 ppm (s, 1H), and cyclohexyl-H peak was confirmed at δ1.42-1.87 ppm (m, 11H). In cyclohexyl chlorosilane, Si—H peak was confirmed at δ4.89 ppm (d, 2H), and cyclohexyl-H peak was confirmed at δ1.32-1.79 ppm (m, 11H).

### Example 12

### Reaction of Cyclohexyl trichlorosilane and Methyldichlorosilane in the Presence of Tetraphenylphosphonium Chloride 374.84 Catalyst

In the same manner as Example 1, 2.5 g (0.011 mol) of cyclohexyl trichlorosilane, 7.6 g (0.066 mol) of methyldichlorosilane, and 0.4 g (0.0011 mol) of tetraphenylphosphonium chloride were put in a 25 ml stainless steel tube and reacted at 120° C. for three hours. The reactants were vacuum-distilled to obtain 1.3 g (yield: 64.5%) of cyclohexyl dichlorosilane and 0.2 g (yield: 12.2%) of cyclohexyl chlorosilane were obtained. Peak confirmation of each product is the same as Example 11 above.

### Example 13

### Reaction of 2-(2-Pyridyl)ethyltrichlorosilane and Methyldichlorosilane in the Presence of Tetrabutylphosphonium Chloride Catalyst

In the same manner as Example 1, 3.0 g (0.013 mol) of 2-(2-pyridyl)ethyltrichlorosilane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 1.8 g (yield: 67.2%) of 2-(2-pyridyl)ethyldichlorosilane and 0.1 g (yield: 4.5%) of 2-(2-pyridyl)ethylchlorosilane were obtained.

The results of analyzing the obtained products by using 300 MHz 1H magnetic resonance showed that, in 2-(2-pyridyl)ethyldichlorosilane, Si—H peak was confirmed at δ5.71 ppm (t, 1H), C—CH₂—CH₂ peak was confirmed at δ2.92 ppm (t, 2H), CH₂—CH₂—Si peak was confirmed at δ1.82 ppm (q, 2H), and Ar—H peak was confirmed at δ7.10-8.52 ppm (m, 4H). In 2-(2-pyridyl)ethylchlorosilane, Si—H peak was confirmed at δ5.32 ppm (t, 2H), C—CH₂—CH₂ peak was confirmed at δ2.88 ppm (t, 2H), CH₂—CH₂—Si peak was confirmed at δ1.85 ppm (m, 2H), and Ar—H peak was confirmed at δ7.04-8.42 ppm (m, 4H).

### Example 14

### Reaction of 2-(bicycloheptyl)trichlorosilane and Methyldichlorosilane in the Presence of Tetrabutylphosphonium Chloride Catalyst

In the same manner as Example 1, 3.0 g (0.013 mol) of 2-(bicycloheptyl)trichlorosilane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 2.0 g (yield: 78.9%) of 2-(bicycloheptyl)dichlorosilane and 0.2 g (yield: 9.6%) of 2-(bicycloheptyl)chlorosilane were obtained.

The results of analyzing the obtained products by using 300 MHz 1H magnetic resonance showed that, in 2-(bicycloheptyl)dichlorosilane, Si—H peak was confirmed at δ5.44 ppm (d, 1H), and —CH₂— peak was confirmed at δ1.28-1.63 ppm (m, 11H). In 2-(bicycloheptyl)chlorosilane, Si—H peak was confirmed at δ5.12 ppm (d, 2H), and —CH₂-peak was confirmed at δ1.23-1.62 ppm (m, 11H).

### Example 15

### Reaction of (Diphenylmethyl)trichlorosilane and Methyldichlorosilane in the Presence of Tetrabutylphosphonium Chloride Catalyst

In the same manner as Example 1, 4.0 g (0.013 mol) of (diphenylmethyl)trichlorosilane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 2.5 g (yield: 72.0%) of (diphenylmethyl)dichlorosilane and 0.3 g (yield: 9.9%) of (diphenylmethyl)chlorosilane were obtained.

The results of analyzing the obtained products by using 300 MHz 1H magnetic resonance showed that, in (diphenylmethyl)dichlorosilane, Si—H peak was confirmed at δ5.77 ppm (d, 1H), Si—CH peak was confirmed at δ3.92 ppm (d, 1H), and Ar—H peak was confirmed at δ7.34-8.25 ppm (m, 10H). In (diphenylmethyl)chlorosilane, Si—H peak was confirmed at δ5.23 ppm (d, 2H), Si—CH peak was confirmed at δ3.82 ppm (t, 1H), and Ar—H peak was confirmed at δ7.38-8.26 ppm (m, 10H).

### Example 16

### Reaction of (Diphenylmethyl)trichlorosilane and Methyldichlorosilane in the Presence of Tetrabutylphosphonium Chloride Catalyst

In the same manner as Example 1, 2.0 g (0.007 mol) of (diphenylmethyl)trichlorosilane, 9.7 g (0.084 mol) of methyldichlorosilane, and 0.2 g (0.0007 mol) of tetrabutylphosphonium chloride were put in a 25 ml stainless steel tube and reacted at 120° C. for three hours. The reactants were vacuum-distilled to obtain 1.0 g (yield: 61.4%) of (diphenylmethyl)chlorosilane and 0.1 g (yield: 5.3%) of (diphenylmethyl)dichlorosilane were obtained. Peak confirmation of each product is the same as Example 15 above.

### Example 17

### Reaction of Acetoxyethyltrichlorosilane and Methyldichlorosilane in the Presence of Tetrabutylphosphonium Chloride Catalyst

In the same manner as Example 1, 3.0 g (0.014 mol) of acetoxyethyltrichlorosilane, 9.7 g (0.084 mol) of methyldichlorosilane, and 0.4 g (0.0014 mol) of tetrabutylphosphonium chloride were put in a 25 ml stainless steel tube and reacted at 120° C. for three hours. The reactants were vacuum-distilled to obtain 1.8 g (yield: 68.7%) of acetoxyethyldichlorosilane and 0.1 g (yield: 4.7%) of acetoxyethylchlorosilane were obtained.

The results of analyzing the obtained products by using 300 MHz 1H magnetic resonance showed that, in acetoxyethyldichlorosilane, Si—H peak was confirmed at δ5.23 ppm (t, 1H), O—CH₂—CH₂ peak was confirmed at δ4.28 ppm (t, 2H), —C—CH₃ peak was confirmed at δ2.17 ppm (s, 3H), and —CH₂—CH₂—Si peak was confirmed at δ1.63 ppm (q, 2H). In acetoxyethylchlorosilane, Si—H peak was confirmed at δ4.83 ppm (t, 2H), —C—CH₂—CH₂ peak was confirmed at δ4.18 ppm (t, 2H), —C—CH₃ peak was confirmed at δ2.09 ppm (s, 3H), and —CH₂—CH₂—Si peak was confirmed at δ1.68 ppm (m, 2H).

### Example 18

### Reaction of 11-Acetoxyundecyltrichlorosilane and Methyldichlorosilane in the Presence of Tetrabutylphosphonium Chloride Catalyst

In the same manner as Example 1, 5.0 g (0.014 mol) of 11-acetoxyundecyltrichlorosilane, 9.7 g (0.084 mol) of methyldichlorosilane, and 0.4 g (0.0014 mol) of tetrabutylphosphonium chloride were put in a 25 ml stainless steel tube and reacted at 120° C. for three hours. The reactants were vacuum-distilled to obtain 3.1 g (yield: 70.1%) of 11-acetoxyundecyldichlorosilane and 0.3 g (yield: 7.7%) of 11-acetoxyundecylchlorosilane were obtained.

The results of analyzing the obtained products by using 300 MHz 1H magnetic resonance showed that, in 11-acetoxyundecyldichlorosilane, Si—H peak was confirmed at δ5.29 ppm (t, 1H), O—CH₂—CH₂ peak was confirmed at 4.08 ppm (t, 2H), —C—CH₃ peak was confirmed at δ2.06 ppm (s, 3H), —CH₂— peak was confirmed at δ1.29-1.57 ppm (m, 18H), and —CH₂—CH₂—Si peak was confirmed at δ1.33 ppm (q, 2H). In 11-acetoxyundecylchlorosilane, Si—H peak was confirmed at δ4.99 ppm (t, 2H), O—CH₂—CH₂ peak was confirmed at δ4.01 ppm (t, 2H), —C—CH₃ peak was confirmed at δ2.01 ppm (s, 3H), —CH₂— peak was confirmed at δ1.25-1.60 ppm (m, 18H), and —CH₂—CH₂—Si peak was confirmed at δ1.30 ppm (m, 2H).

### Example 19

### Reaction of (Heptadecafluoro-1,1,2,2-tetrahydrodecyl)trichlorosilane and Methyldichlorosilane in the Presence of Tetrabutylphosphonium Chloride Catalyst

In the same manner as Example 1, 7.0 g (0.012 mol) of (heptadecafluoro-1,1,2,2-tetrahydrodecyl)trichlorosilane, 8.3 g (0.072 mol) of methyldichlorosilane, and 0.4 g (0.0012 mol) of tetrabutylphosphonium chloride were put in a 25 ml stainless steel tube and reacted at 80° C. for three hours. The reactants were vacuum-distilled to obtain 5.3 g (yield: 80.7%) of (heptadecafluoro-1,1,2,2-tetrahydrodecyl)dichlorosilane and 0.4 g (yield: 6.5%) of (heptadecafluoro-1,1,2,2-tetrahydrodecyl)chlorosilane were obtained.

The results of analyzing the obtained products by using 300 MHz 1H magnetic resonance showed that, in (heptadecafluoro-1,1,2,2-tetrahydrodecyl)dichlorosilane, Si—H peak was confirmed at δ5.62 ppm (t, 1H), Si—CH₂—CH₂ peak was confirmed at δ2.30 ppm (q, 2H), and CF₂—CH₂—CH₂ peak was confirmed at δ1.48 ppm (t, 2H). In (heptadecafluoro-1,1,2,2-tetrahydrodecyl)chlorosilane, Si—H peak was confirmed at δ5.24 ppm (t, 2H), Si—CH₂—CH₂ peak was confirmed at δ2.33 ppm (m, 2H), and CF₂—CH₂—CH₂ peak was confirmed at δ1.44 ppm (t, 2H).

### Example 20

### Reaction of Tridecafluoro-1,1,2,2-tetrahydrooctyltrichlorosilane and Methyldichlorosilane in the Presence of Tetrabutylphosphonium Chloride Catalyst

In the same manner as Example 1, 5.7 g (0.012 mol) of tridecafluoro-1,1,2,2-tetrahydrooctyltrichlorosilane, 8.3 g (0.072 mol) of methyldichlorosilane, and 0.4 g (0.0012 mol) of tetrabutylphosphonium chloride were put in a 25 ml stainless steel tube and reacted at 80° C. for three hours. The reactants were vacuum-distilled to obtain 3.1 g (yield: 57.8%) of tridecafluoro-1,1,2,2-tetrahydrooctyldichlorosilane and 0.3 g (yield: 6.1%) of tridecafluoro-1,1,2,2-tetrahydrooctylchlorosilane were obtained.

The results of analyzing the obtained products by using 300 MHz 1H magnetic resonance showed that, in tridecafluoro-1,1,2,2-tetrahydrooctyldichlorosilane, Si—H peak was confirmed at δ5.56 ppm (t, 1H), Si—CH₂—CH₂ peak was confirmed at δ2.36 ppm (t, 2H), and CF₂—CH₂—CH₂ peak was confirmed at δ1.67 ppm (t, 2H). In tridecafluoro-1,1,2,2-tetrahydrooctylchlorosilane, Si—H peak was confirmed at δ5.23 ppm (t, 2H), Si—CH₂—CH₂ peak was confirmed at δ2.38 ppm (m, 2H), and CF₂—CH₂—CH₂ peak was confirmed at δ1.72 ppm (t, 2H).

### Example 21

### Reaction of Tridecafluoro-1,1,2,2-tetrahydrooctyltrichlorosilane and Methyldichlorosilane in the Presence of Benzyltriphenylphosphonium Chloride 388.87 Catalyst

In the same manner as Example 1, 5.7 g (0.012 mol) of tridecafluoro-1,1,2,2-tetrahydrooctyltrichlorosilane, 8.3 g (0.072 mol) of methyldichlorosilane, and 0.5 g (0.0012 mol) of benzyltriphenylphosphonium chloride were put in a 25 ml stainless steel tube and reacted at 80° C. for three hours. The reactants were vacuum-distilled to obtain 3.3 g (yield: 61.5%) of tridecafluoro-1,1,2,2-tetrahydrooctyldichlorosilane and 0.2 g (yield: 4.1%) of tridecafluoro-1,1,2,2-tetrahydrooctylchlorosilane were obtained. Peak confirmation of each product is the same as Example 20 above.

### Example 22

### Reaction of (4-Fluorobenzyl)trichlorosilane and Methyldichlorosilane in the Presence of Benzyltriphenylphosphonium Chloride Catalyst

In the same manner as Example 1, 3.5 g (0.014 mol) of (4-fluorobenzyl)trichlorosilane, 9.7 g (0.084 mol) of methyldichlorosilane, and 0.5 g (0.0014 mol) of benzyltriphenylphosphonium chloride were put in a 25 ml stainless steel tube and reacted at 80° C. for three hours. The reactants were vacuum-distilled to obtain 2.1 g (yield: 71.7%) of (4-fluorobenzyl)dichlorosilane and 0.1 g (yield: 4.1%) of (4-fluorobenzyl)chlorosilane were obtained.

The results of analyzing the obtained products by using 300 MHz 1H magnetic resonance showed that, in (4-fluorobenzyl)dichlorosilane, Si—H peak was confirmed at δ5.71 ppm (t, 1H), Si—CH₂—C peak was confirmed at δ2.92 ppm (d, 2H), and Ar—H peak was confirmed at δ7.10 ppm (m, 4H). In (4-fluorobenzyl)chlorosilane, Si—H peak was confirmed at δ5.33 ppm (t, 2H), Si—CH₂—C peak was confirmed at δ2.84 ppm (t, 2H), and Ar—H peak was confirmed at δ7.13 ppm (m, 4H).

### Example 23

### Reaction of 3-Chloropropyltrichlorosilane and Methyldichlorosilane in the Presence of Tetrabutylphosphonium Chloride Catalyst

In the same manner as Example 1, 3.0 g (0.014 mol) of 3-chloropropyltrichlorosilane, 9.7 g (0.084 mol) of methyldichlorosilane, and 0.4 g (0.0014 mol) of tetrabutylphosphonium chloride were put in a 25 ml stainless steel tube and reacted at 80° C. for three hours. The reactants were vacuum-distilled to obtain 2.0 g (yield: 80.5%) of 3-chloropropyldichlorosilane and 0.2 g (yield: 10.0%) of 3-chloropropylchlorosilane were obtained.

The results of analyzing the obtained products by using 300 MHz 1H magnetic resonance showed that, in 3-chloropropyldichlorosilane, Si—H peak was confirmed at δ5.57 ppm (t, 1H), Cl—CH₂ peak was confirmed at δ3.60 ppm (t, 2H), CH₂—CH₂—CH₂ peak was confirmed at δ1.99 ppm (m, 2H), and CH₂—CH₂—Si peak was confirmed at δ1.37 ppm (t, 2H). In 3-chloropropylchlorosilane, Si—H peak was confirmed at δ5.13 ppm (t, 2H), Cl —CH₂ peak was confirmed at δ3.53 ppm (t, 2H), CH₂—CH₂—CH₂ peak was confirmed at δ2.07 ppm (m, 2H), and CH₂—CH₂—Si peak was confirmed at δ1.38 ppm (t, 2H).

### Example 24

### Reaction of 11-Chloroundecyltrichlorosilane and Methyldichlorosilane in the Presence of Tetrabutylphosphonium Chloride Catalyst

In the same manner as Example 1, 4.5 g (0.014 mol) of 11-chloroundecyltrichlorosilane, 9.7 g (0.084 mol) of methyldichlorosilane, and 0.4 g (0.0014 mol) of tetrabutylphosphonium chloride were put in a 25 ml stainless steel tube and reacted at 80° C. for three hours. The reactants were vacuum-distilled to obtain 2.9 g (yield: 71.4%) of 11-chloroundecyldichlorosilane and 0.3 g (yield: 8.4%) of 11-chloroundecylchlorosilane were obtained.

The results of analyzing the obtained products by using 300 MHz 1H magnetic resonance showed that, in 11-chloroundecyldichlorosilane, Si—H peak was confirmed at δ5.36 ppm (t, 1H), Cl—CH₂ peak was confirmed at δ3.38 ppm (t, 2H), —CH₂— peak was confirmed at δ1.56-1.84 ppm (m, 18H), and CH₂—CH₂—Si peak was confirmed at δ1.37 ppm (t, 2H). In 11-chloroundecylchlorosilane, Si—H peak was confirmed at δ4.89 ppm (t, 2H), Cl—CH₂ peak was confirmed at δ3.48 ppm (t, 2H), —CH₂— peak was confirmed at δ1.49-1.75 ppm (m, 18H), and CH₂—CH₂—Si peak was confirmed at δ1.37 ppm (t, 2H).

### Example 25

### Reaction of Cyanoethyltrichlorosilane and Methyldichlorosilane in the Presence of Tetrabutylphosphonium Chloride Catalyst

In the same manner as Example 1, 2.5 g (0.013 mol) of cyanoethyltrichlorosilane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 1.5 g (yield: 74.9%) of cyanoethyldichlorosilane and 0.1 g (yield: 6.4%) of cyanoethylchlorosilane were obtained.

The results of analyzing the obtained products by using 300 MHz 1H magnetic resonance showed that, in cyanoethyldichlorosilane, Si—H peak was confirmed at δ5.15 ppm (t, 1H), NC—CH₂—CH₂ peak was confirmed at δ2.54 ppm (t, 2H), and —CH₂—CH₂—Si peak was confirmed at δ1.72 ppm (t, 2H). In cyanoethylchlorosilane, Si—H peak was confirmed at δ4.85 ppm (t, 2H), NC—CH₂—CH₂ peak was confirmed at δ2.53 ppm (t, 2H), and —CH₂—CH₂—Si peak was confirmed at δ1.70 ppm (t, 2H).

### Example 26

### Reaction of Cyanoethyltrichlorosilane and Methyldichlorosilane in the Presence of Tetrabutylphosphonium Chloride Catalyst

In the same manner as Example 1, 1.0 g (0.005 mol) of cyanoethyltrichlorosilane, 6.9 g (0.060 mol) of methyldichlorosilane, and 0.2 g (0.0005 mol) of tetrabutylphosphonium chloride were put in a 25 ml stainless steel tube and reacted at 120° C. for three hours. The reactants were vacuum-distilled to obtain 0.5 g (yield: 83.6%) of cyanoethylchlorosilane and 0.1 g (yield: 13.0%) of cyanoethyldichlorosilane were obtained. Peak confirmation of each product is the same as Example 25 above.

### Example 27

### Reaction of Allyltrichlorosilane and Methyldichlorosilane in the Presence of Tetrabutylphosphonium Chloride Catalyst

In the same manner as Example 1, 2.5 g (0.014 mol) of allyltrichlorosilane, 9.0 g (0.084 mol) of methyldichlorosilane, and 0.4 g (0.0014 mol) of tetrabutylphosphonium chloride were put in a 25 ml stainless steel tube and reacted at 120° C. for three hours. The reactants were vacuum-distilled to obtain 1.4 g (yield: 70.9%) of allyldichlorosilane and 0.2 g (yield: 13.4%) of allylchlorosilane were obtained.

The results of analyzing the obtained products by using 300 MHz 1H magnetic resonance showed that, in allyldichlorosilane, Si—H peak was confirmed at δ5.46 ppm (t, 1H), CH₂═CH—CH₂ peak was confirmed at δ5.69-5.83 ppm (m, 1H), CH₂═CH peak was confirmed at δ5.17 ppm (d, 2H), and CH—CH₂—Si peak was confirmed at δ2.17 ppm (t, 2H). In allylchlorosilane, Si—H peak was confirmed at δ5.09 ppm (t, 2H), CH₂═CH—CH₂ peak was confirmed at δ5.61-5.93 ppm (m, 1H), CH₂═CH peak was confirmed at δ5.23 ppm (d, 2H), and CH—CH₂—Si peak was confirmed at δ2.13 ppm (t, 2H).

### Example 28

### Reaction of 5-Hexenyltrichlorosilane and Methyldichlorosilane in the Presence of Tetraphenylphosphonium Chloride Catalyst

In the same manner as Example 1, 3.0 g (0.014 mol) of 5-hexenyltrichlorosilane, 9.7 g (0.084 mol) of methyldichlorosilane, and 0.5 g (0.0014 mol) of tetraphenylphosphonium chloride were put in a 25 ml stainless steel tube and reacted at 80° C. for three hours. The reactants were vacuum-distilled to obtain 1.7 g (yield: 66.3%) of 5-hexenyldichlorosilane and 0.2 g (yield: 9.6%) of 5-hexenylchlorosilane were obtained.

The results of analyzing the obtained products by using 300 MHz 1H magnetic resonance showed that, in 5-hexenyldichlorosilane, Si—H peak was confirmed at δ5.47 ppm (t, 1H), —CH₂— peak was confirmed at δ1.17-1.56 ppm (m, 8H), CH₂═CH peak was confirmed at δ5.89 ppm (q, 1H), and CH₂═CH peak was confirmed at δ5.02 ppm (d, 2H). In 5-hexenylchlorosilane, Si—H peak was confirmed at δ5.17 ppm (t, 2H), —CH₂— peak was confirmed at δ1.12-1.51 ppm (m, 8H), CH₂═CH peak was confirmed at δ5.83 ppm (q, 1H), and CH₂═CH peak was confirmed at δ4.99 ppm (d, 2H).

### Example 29

### Reaction of 7-Octenyltrichlorosilane and Methyldichlorosilane in the Presence of Tetraphenylphosphonium Chloride Catalyst

In the same manner as Example 1, 3.5 g (0.014 mol) of 7-octenyltrichlorosilane, 9.7 g (0.084 mol) of methyldichlorosilane, and 0.5 g (0.0014 mol) of tetraphenylphosphonium chloride were put in a 25 ml stainless steel tube and reacted at 80° C. for three hours. The reactants were vacuum-distilled to obtain 1.9 g (yield: 64.2%) of 7-octenyldichlorosilane and 0.1 g (yield: 4.0%) of 7-octenylchlorosilane were obtained.

The results of analyzing the obtained products by using 300 MHz 1H magnetic resonance showed that, in 7-octenyldichlorosilane, Si—H peak was confirmed at δ5.67 ppm (t, ¹H), —CH₂— peak was confirmed at δ1.27-1.86 ppm (m, 12H), CH₂═CH peak was confirmed at δ5.99 ppm (q, 1H), and CH₂═CH peak was confirmed at δ5.13 ppm (d, 2H). In 7-octenylchlorosilane, Si—H peak was confirmed at δ5.37 ppm (t, 2H), —CH₂— peak was confirmed at δ1.32-1.93 ppm (m, 12H), CH₂═CH peak was confirmed at δ5.89 ppm (q, 1H), and CH₂═CH peak was confirmed at δ5.11 ppm (d, 2H).

### Example 30

### Reaction of 11-Phenoxyundecyltrichlorosilane and Methyldichlorosilane in the Presence of Tetrabutylphosphonium Chloride Catalyst

In the same manner as Example 1, 5.0 g (0.013 mol) of 11-phenoxyundecyltrichlorosilane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 2.9 g (yield: 64.2%) of 11-phenoxyundecyldichlorosilane and 0.3 g (yield: 6.6%) of 11-phenoxyundecylchlorosilane were obtained.

The results of analyzing the obtained products by using 300 MHz 1H magnetic resonance showed that, in 11-phenoxyundecyldichlorosilane, Si—H peak was confirmed at δ5.33 ppm (t, 1H), O—CH₂ peak was confirmed at δ3.92 ppm (t, 2H), —CH₂— peak was confirmed at δ1.39-1.61 ppm (m, 18H), CH₂—CH₂—Si peak was confirmed at δ1.18 ppm (q, 2H), and Ar—H peak was confirmed at δ66.77-7.15 ppm (m, 5H). In 11-phenoxyundecylchlorosilane, Si—H peak was confirmed at δ4.93 ppm (t, 2H), O—CH₂ peak was confirmed at δ3.99 ppm (t, 2H), —CH₂— peak was confirmed at δ1.33-1.60 ppm (m, 18H), CH₂—CH₂—Si peak was confirmed at δ1.12 ppm (q, 2H), and Ar—H peak was confirmed at δ6.90-7.25 ppm (m, 5H).

### Example 31

### Reaction of 3-Naphtoxypropyltrichlorosilane and Methyldichlorosilane in the Presence of Tetrabutylphosphonium Chloride Catalyst

In the same manner as Example 1, 4.5 g (0.014 mol) of 3-naphtoxypropyltrichlorosilane, 9.7 g (0.084 mol) of methyldichlorosilane, and 0.4 g (0.0014 mol) of tetrabutylphosphonium chloride were put in a 25 ml stainless steel tube and reacted at 120° C. for three hours. The reactants were vacuum-distilled to obtain 3.0 g (yield: 75.1%) of 3-naphtoxypropyldichlorosilane and 0.5 g (yield: 14.2%) of 3-naphtoxypropylchlorosilane were obtained.

The results of analyzing the obtained products by using 300 MHz 1H magnetic resonance showed that, in 3-naphtoxypropyldichlorosilane, Si—H peak was confirmed at δ5.43 ppm (t, 1H), O—CH₂ peak was confirmed at δ3.94 ppm (t, 2H), CH₂—CH₂—CH₂ peak was confirmed at δ1.68 ppm (m, 2H), CH₂—CH₂—Si peak was confirmed at δ1.24 ppm (q, 2H), and Ar—H peak was confirmed at δ6.97-7.60 ppm (m, 7H). In 3-naphtoxypropylchlorosilane, Si—H peak was confirmed at δ5.23 ppm (t, 2H), O—CH₂ peak was confirmed at δ3.98 ppm (t, 2H), CH₂—CH₂—CH₂ peak was confirmed at δ1.61 ppm (m, 2H), CH₂—CH₂—Si peak was confirmed at δ1.19 ppm (q, 2H), and Ar—H peak was confirmed at δ6.91-7.53 ppm (m, 7H).

### Example 32

### Reaction of Bistrichlorosilylmethane and Methyldichlorosilane in the Presence of Tetrabutylphosphonium Chloride Catalyst

In the same manner as Example 1, 5.0 g (0.018 mol) of bistrichlorosilylmethane, 12.2 g (0.106 mol) of methyldichlorosilane, and 0.5 g (0.0018 mol) of tetrabutylphosphonium chloride were put in a 25 ml stainless steel tube and reacted at 80° C. for three hours. The reactants were vacuum-distilled to obtain 3.3 g (yield: 75.0%) of (trichlorosilylmethyl)dichlorosilane and 0.3 g (yield: 7.8%) of bisdichlorosilylmethane were obtained.

The results of analyzing the obtained products by using 300 MHz 1H magnetic resonance showed that, in (trichlorosilylmethyl)dichlorosilane, Si—H peak was confirmed at δ5.71 ppm (t, 1H), and —CH₂— peak was confirmed at δ1.63 ppm (d, 2H). In bisdichlorosilylmethane, Si—H peak was confirmed at δ5.21 ppm (t, 2H), and —CH₂— peak was confirmed at δ1.63 ppm (t, 2H).

### Example 33

### Reaction of Bistrichlorosilylmethane and

Methyldichlorosilane in the Presence of Benzyltributylphosphonium Chloride 328.9 Catalyst

In the same manner as Example 1, 5.0 g (0.018 mol) of bistrichlorosilylmethane, 12.2 g (0.108 mol) of methyldichlorosilane, and 0.6 g (0.0018 mol) of benzyltributylphosphonium chloride were put in a 25 ml stainless steel tube and reacted at 80° C. for three hours. The reactants were vacuum-distilled to obtain 3.1 g (yield: 69.3%) of (trichlorosilylmethyl)dichlorosilane and 0.2 g (yield: 5.2%) of bisdichlorosilylmethane were obtained. Peak confirmation of each product is the same as Example 32 above.

### Example 34

### Reaction of Bistrichlorosilylpropane and

Methyldichlorosilane in the Presence of Tetrabutylphosphonium Chloride Catalyst

In the same manner as Example 1, 4.0 g (0.013 mol) of bistrichlorosilylpropane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 2.5 g (yield: 69.5%) of 1-(dichlorosilyl)-3-(trichlorosilyl)propane and 0.2 g (yield: 6.4%) of bisdichlorosilylpropane were obtained.

The results of analyzing the obtained products by using 300 MHz 1H magnetic resonance showed that, in 1-(dichlorosilyl)-3-(trichlorosilyl)propane, Si—H peak was confirmed at δ5.68 ppm (t, 1H), and —CH₂— peak was confirmed at δ1.23-1.68 ppm (t, 6H). In bisdichlorosilylpropane, Si—H peak was confirmed at δ5.28 ppm (t, 2H), and —CH₂-peak was confirmed at δ1.20-1.66 ppm (t, 6H).

### Example 35

### Reaction of Bistrichlorosilylpropane and Methyldichlorosilane in the Presence of Tetrabutylphosphonium Chloride Catalyst

In the same manner as Example 1, 2.0 g (0.006 mol) of bistrichlorosilylpropane, 8.3 g (0.072 mol) of methyldichlorosilane, and 0.2 g (0.0006 mol) of tetrabutylphosphonium chloride were put in a 25 ml stainless steel tube and reacted at 120° C. for three hours. The reactants were vacuum-distilled to obtain 1.2 g (yield: 82.6%) of bisdichlorosilylpropane and 0.1 g (yield: 6.0%) of 1-(dichlorosilyl)-3-(trichlorosilyl)propane were obtained. Peak confirmation of each product is the same as Example 34 above.

### Example 36

### Reaction of Bistrichlorosilyloctane and Methyldichlorosilane in the Presence of Tetrabutylphosphonium Chloride Catalyst

In the same manner as Example 1, 2.6 g (0.007 mol) of bistrichlorosilyloctane, 9.7 g (0.084 mol) of methyldichlorosilane, and 0.2 g (0.0007 mol) of tetrabutylphosphonium chloride were put in a 25 ml stainless steel tube and reacted at 120° C. for three hours. The reactants were vacuum-distilled to obtain 1.3 g (yield: 59.5%) of bisdichlorosilyloctane and 0.1 g (yield: 4.1%) of 1-(dichlorosilyl)-8-(trichlorosilyl)octane were obtained.

The results of analyzing the obtained products by using 300 MHz 1H magnetic resonance showed that, in bisdichlorosilyloctane, Si—H peak was confirmed at δ5.32 ppm (t, 2H), Si—CH₂— peak was confirmed at δ1.46 ppm (t, 4H), and —CH₂— peak was confirmed at δ1.19-1.37 ppm (m, 12H). In 1-(dichlorosilyl)-8-(trichlorosilyl)octane, Si—H peak was confirmed at δ5.62 ppm (t, 1H), Si—CH₂— peak was confirmed at δ1.41 ppm (t, 4H), and —CH₂-peak was confirmed at δ1.12-1.31 ppm (m, 12H).

### Example 37

### Reaction of 2,5-Bis(trichlorosilyl)-1,1,4,4-tetrachloro-1,4-disilacyclohexane and Methyldichlorosilane in the Presence of Tetrabutylphosphonium Chloride Catalyst

In the same manner as Example 1, 3.0 g (0.0058 mol) of 2,5-bis(trichlorosilyl)-1,1,4,4-terachloro-1,4-disilacyclohexane, 8.0 g (0.069 mol) of methyldichlorosilane, and 0.2 g (0.0006 mol) of tetrabutylphosphonium chloride were put in a 25 ml stainless steel tube and reacted at 80° C. for three hours. The reactants were vacuum-distilled to obtain 2.1 g (yield: 80.1%) of 2,5-bis(dichlorosilyl)-1,1,4,4-tetrachloro-1,4-disilacyclohexane and 0.2 g (yield: 7.1%) of 2-(dichlorosilyl)-5-(trichlorosilyl)-1,1,4,4-tetrachloro-1,4-disilacyclohexane were obtained.

The results of analyzing the obtained products by using 300 MHz 1H magnetic resonance showed that, in 2,5-bis(dichlorosilyl)-1,1,4,4-tetrachloro-1,4-disilacyclohexane, Si—H peak was confirmed at δ5.34 ppm (d, 2H), Si—CH—Si peak was confirmed at δ1.82 ppm (t, 2H), and Si—CH₂—C peak was confirmed at δ1.57 ppm (d, 4H).

In 2-(dichlorosilyl)-5-(trichlorosilyl)-1,1,4,4-tetrachloro-1,4-disilacyclohexane, Si—H peak was confirmed at δ5.54 ppm (d, 1H), Si—CH—Si peak was confirmed at δ1.75-1.88 ppm (m, 2H), and Si—CH₂—C peak was confirmed at δ1.57 ppm (d, 4H).

### Example 38

### Reaction of 1,4-Bis(trichlorosilyl)benzene and Methyldichlorosilane in the Presence of Tetrabutylphosphonium Chloride Catalyst

In the same manner as Example 1, 4.0 g (0.012 mol) of 1,4-bis(trichlorosilyl)benzene, 8.3 g (0.072 mol) of methyldichlorosilane, and 0.4 g (0.0012 mol) of tetrabutylphosphonium chloride were put in a 25 ml stainless steel tube and reacted at 120° C. for three hours. The reactants were vacuum-distilled to obtain 2.5 g (yield: 75.5%) of 1-(dichlorosilyl)-4-(trichlorosilyl)benzene and 0.2 g (yield: 6.0%) of 1,4-bis(dichlorosilyl)benzene were obtained.

The results of analyzing the obtained products by using 300 MHz 1H magnetic resonance showed that, in 1-(dichlorosilyl)-4-(trichlorosilyl)benzene, Si—H peak was confirmed at δ5.84 ppm (s, 1H), and Ar—H peak was confirmed at δ7.34 ppm (d, 4H). In 1,4-bis(dichlorosilyl)benzene, Si—H peak was confirmed at δ5.44 ppm (s, 2H), and Ar—H peak was confirmed at δ7.34 ppm (d, 4H).

### Example 39

### Reaction of 1,4-Bis(trichlorosilyl)benzene and Methyldichlorosilane in the Presence of Tetrabutylphosphonium Chloride Catalyst

In the same manner as Example 1, 2.0 g (0.006 mol) of 1,4-bis(trichlorosilyl)benzene, 8.3 g (0.072 mol) of methyldichlorosilane, and 0.2 g (0.0006 mol) of tetrabutylphosphonium chloride were put in a 25 ml stainless steel tube and reacted at 80° C. for three hours. The reactants were vacuum-distilled to obtain 1.1 g (yield: 66.4%) of 1,4-bis(dichlorosilyl)benzene and 0.1 g (yield: 5.4%) of 1-(dichlorosilyl)-4-(trichlorosilyl)benzene were obtained. Peak confirmation of each product is the same as Example 38 above.

### Example 40

### Reaction of 4,4″-Bis(trichlorosilylmethyl)biphenyl and Methyldichlorosilane in the Presence of Tetrabutylphosphonium Chloride Catalyst

In the same manner as Example 1, 6.0 g (0.013 mol) of 4,4′-bis(trichlorosilylmethyl)biphenyl, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 4.0 g (yield: 74.2%) of 4-(dichlorosilylmethyl)-4″-(trichlorosilylmethyl)biphenyl and 0.3 g (yield: 7.4%) of 4,4′-bis(dichlorosilylmethyl)biphenyl were obtained.

The results of analyzing the obtained products by using 300 MHz 1H magnetic resonance showed that, in 4-(dichlorosilylmethyl)-4′-(trichlorosilylmethyl)biphenyl, Si—H peak was confirmed at δ5.94 ppm (t, 1H), Ar—CH₂—Si peak was confirmed at δ2.28-2.63 ppm (ds, 4H), and Ar—H peak was confirmed at δ7.14-7.37 ppm (m, 8H). In 4,4′-bis(dichlorosilylmethyl)biphenyl, Si—H peak was confirmed at δ5.54 ppm (t, 2H), Ar—CH₂—Si peak was confirmed at δ2.38 ppm (d, 4H), and Ar—H peak was confirmed at δ7.10-7.42 ppm (m, 8H).

### Example 41

### Reaction of 4,4″-Bis(trichlorosilylmethyl)biphenyl and Methyldichlorosilane in the Presence of Tetrabutylphosphonium Chloride Catalyst

In the same manner as Example 1, 3.0 g (0.007 mol) of 4,4″-bis(trichlorosilylmethyl)biphenyl, 9.7 g (0.084 mol) of methyldichlorosilane, and 0.2 g (0.0007 mol) of tetrabutylphosphonium chloride were put in a 25 ml stainless steel tube and reacted at 120° C. for three hours. The reactants were vacuum-distilled to obtain 1.8 g (yield: 67.6%) of 4,4′-bis(dichlorosilylmethyl)biphenyl and 0.2 g (yield: 7.5%) of 4-(dichlorosilylmethyl)-4′-(trichlorosilylmethyl)biphenyl were obtained. Peak confirmation of each product is the same as Example 40 above.

### Example 42

### Reaction of Phenyltrichlorosilane and Methyldichlorosilane in the Presence of Tetrabutylphosphonium Chloride Catalyst

In the same manner as Example 1, 2.5 g (0.012 mol) of phenyltrichlorosilane, 8.1 g (0.072 mol) of methyldichlorosilane, and 0.4 g (0.0012 mol) of tetrabutylphosphonium chloride were put in a 25 ml stainless steel tube and reacted at 80° C. for three hours. The reactants were vacuum-distilled to obtain 1.7 g (yield: 80.0%) of phenyldichlorosilane and 0.1 g (yield: 5.8%) of phenylchlorosilane were obtained.

The results of analyzing the obtained products by using 300 MHz 1H magnetic resonance showed that, in phenyldichlorosilane, Si—H peak was confirmed at δ5.99 ppm (s, 1H), and Ar—H peak was confirmed at δ7.48-7.84 ppm (m, 5H). In phenylchlorosilane, Si—H peak was confirmed at δ5.52 ppm (s, 2H), and Ar—H peak was confirmed at δ7.58-7.87 ppm (m, 5H).

### Example 43

### Reaction of Phenyltrichlorosilane and Methyldichlorosilane in the Presence of Immobilized Silicone Resin Catalyst Containing a Quaternary Phosphonium salt Catalyst

In the same manner as Example 1, 2.5 g (0.012 mol) of phenyltrichlorosilane, 8.1 g (0.071 mol) of methyldichlorosilane, and 0.8 g of silicone resin [(RSiO3/2)n, R═{3-(tributylphosphonium)propyl}chloride] were put in a 25 ml stainless steel tube and reacted at 80° C. for three hours. The reactants were vacuum-distilled to obtain 1.3 g (yield: 61.2%) of phenyldichlorosilane and 0.1 g (yield: 5.8%) of phenylchlorosilane were obtained. Peak confirmation of each product is the same as Example 42 above.

### Example 44

### Reaction of Benzyltrichlorosilane and Methyldichlorosilane in the Presence of Benzyltriethylphosphonium Chloride Catalyst

In the same manner as Example 1, 3.0 g (0.013 mol) of benzyltrichlorosilane, 9.0 g (0.078 mol) of methyldichlorosilane, and 0.5 g (0.0013 mol) of benzyltriethylphosphonium chloride were put in a 25 ml stainless steel tube and reacted at 80° C. for three hours. The reactants were vacuum-distilled to obtain 1.9 g (yield: 76.4%) of benzyldichlorosilane and 0.1 g (yield: 4.9%) of benzylchlorosilane were obtained.

The results of analyzing the obtained products by using 300 MHz 1H magnetic resonance showed that, in benzyldichlorosilane, Si—H peak was confirmed at δ5.88 ppm (t, 1H), Si—CH₂—C peak was confirmed at δ2.78 ppm (d, 2H), and Ar—H peak was confirmed at δ7.10 ppm (m, 5H). In benzylchlorosilane, Si—H peak was confirmed at δ5.52 ppm (t, 2H), Si—CH₂—C peak was confirmed at δ2.70 ppm (t, 2H), and Ar—H peak was confirmed at δ7.13 ppm (m, 5H).

### Example 45

### Reaction of (2-Phenylethyl)trichlorosilane and Methyldichlorosilane in the Presence of Benzyltriethylphosphonium Chloride Catalyst

In the same manner as Example 1, 3.0 g (0.013 mol) of (2-phenylethyl)trichlorosilane, 9.0 g (0.078 mol) of methyldichlorosilane, and 0.5 g (0.0013 mol) of benzyltriethylphosphonium chloride were put in a 25 ml stainless steel tube and reacted at 80° C. for three hours. The reactants were vacuum-distilled to obtain 2.0 g (yield: 75.0%) of (2-phenylethyl)dichlorosilane and 0.3 g (yield: 13.5%) of (2-phenylethyl)chlorosilane were obtained.

The results of analyzing the obtained products by using 300 MHz 1H magnetic resonance showed that, in (2-phenylethyl)dichlorosilane, Si—H peak was confirmed at δ5.83 ppm (t, 1H), Ar—CH₂—C peak was confirmed at δ2.68 ppm (t, 2H), Si—CH₂—C peak was confirmed at δ1.72 ppm (q, 2H), and Ar—H peak was confirmed at δ7.10 ppm (m, 5H). In (2-phenylethyl)chlorosilane, Si—H peak was confirmed at δ5.43 ppm (t, 2H), Ar—CH₂—C peak was confirmed at δ2.71 ppm (t, 2H), Si—CH₂—C peak was confirmed at δ1.75 ppm (m, 2H), and Ar—H peak was confirmed at δ7.14 ppm (m, 5H).

### Example 46

### Reaction of 9-Trichlorosilylanthrathene and Methyldichlorosilane in the Presence of Tetrabutylphosphonium Chloride Catalyst

In the same manner as Example 1, 4.0 g (0.013 mol) of 9-trichlorosilylanthrathene, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 2.8 g (yield: 77.7%) of 9-dichlorosilylanthrathene and 0.1 g (yield: 3.2%) of 9-chlorosilylanthrathene were obtained.

The results of analyzing the obtained products by using 300 MHz 1H magnetic resonance showed that, in 9-dichlorosilylanthrathene, Si—H peak was confirmed at δ5.88 ppm (s, 1H), and Ar—H peak was confirmed at δ7.10-7.43 ppm (m, 9H). In 9-chlorosilylanthrathene, Si—H peak was confirmed at δ5.33 ppm (s, 2H), and Ar—H peak was confirmed at δ7.14-7.46 ppm (m, 9H).

### Example 47

### Reaction of 1-Naphtyltrichlorosilane and Methyldichlorosilane in the Presence of Tetrabutylphosphonium Chloride Catalyst

In the same manner as Example 1, 3.5 g (0.013 mol) of 1-naphtyltrichlorosilane, 9.0 g (0.078 mol) of methyldichlorosilane, and 0.4 g (0.0013 mol) of tetrabutylphosphonium chloride were put in a 25 ml stainless steel tube and reacted at 120° C. for three hours. The reactants were vacuum-distilled to obtain 2.4 g (yield: 81.3%) of 1-naphtyldichlorosilane and 0.1 g (yield: 4.0%) of 1-naphtylchlorosilane were obtained.

The results of analyzing the obtained products by using 300 MHz 1H magnetic resonance showed that, in 1-naphtyldichlorosilane, Si—H peak was confirmed at δ5.79 ppm (s, 1H), and Ar—H peak was confirmed at δ7.02-7.33 ppm (m, 7H). In 1-naphtylchlorosilane, Si—H peak was confirmed at δ5.31 ppm (s, 2H), and Ar—H peak was confirmed at δ7.05-7.35 ppm (m, 7H).

### Example 48

### Reaction of 9-Trichlorosilylmethylanthrathene and Methyldichlorosilane in the Presence of Tetrabutylphosphonium Chloride Catalyst

In the same manner as Example 1, 4.5 g (0.014 mol) of 9-trichlorosilylmethylanthrathene, 9.7 g (0.084 mol) of methyldichlorosilane, and 0.4 g (0.0014 mol) of tetrabutylphosphonium chloride were put in a 25 ml stainless steel tube and reacted at 120° C. for three hours. The reactants were vacuum-distilled to obtain 3.3 g (yield: 80.9%) of 9-dichlorosilylmethylanthrathene and 0.3 g (yield: 8.3%) of 9-chlorosilylmethylanthrathene were obtained.

The results of analyzing the obtained products by using 300 MHz 1H magnetic resonance showed that, in 9-dichlorosilylmethylanthrathene, Si—H peak was confirmed at δ6.01 ppm (t, 1H), Si—CH₂—Ar peak was confirmed at δ2.48 ppm (d, 2H), and Ar—H peak was confirmed at δ7.20-7.42 ppm (m, 9H). In 9-chlorosilylmethylanthrathene, Si—H peak was confirmed at δ5.52 ppm (t, 2H), Si—CH₂—Ar peak was confirmed at δ2.34 ppm (t, 2H), and Ar—H peak was confirmed at δ7.14-7.41 ppm (m, 9H).

### Example 49

### Reaction of 1,1,1,3,3-Pentachloro-1,3-disilabutane and Methyldichlorosilane in the Presence of Benzyltributylphosphonium Chloride Catalyst

In the same manner as Example 1, 4.0 g (0.015 mol) of 1,1,1,3,3-pentachloro-1,3-disilabutane, 10.4 g (0.090 mol) of methyldichlorosilane, and 0.5 g (0.0015 mol) of benzyltributylphosphonium chloride were put in a 25 ml stainless steel tube and reacted at 80° C. for three hours. The reactants were vacuum-distilled to obtain 2.7 g (yield: 78.9%) of 1,1,3,3-tetrachloro-1,3-disilabutane and 0.2 g (yield: 6.9%) of 1,1,3-trichloro-1,3-disilabutane were obtained.

The results of analyzing the obtained products by using 300 MHz 1H magnetic resonance showed that, in 1,1,3,3-tetrachloro-1,3-disilabutane, Si—H peak was confirmed at δ5.68 ppm (t, 1H), —CH₂— peak was confirmed at δ1.33 ppm (d, 2H), and Si—CH₃ peak was confirmed at δ0.94 ppm (s, 3H). In 1,1,3-trichloro-1,3-disilabutane, Si—H peak was confirmed at δ5.24 ppm (t, 2H), —CH₂— peak was confirmed at δ1.39 ppm (t, 2H), and Si—CH₃ peak was confirmed at δ0.99 ppm (s, 3H).

### Example 50

### Reaction of 1,1,1-Trichloro-3,3-dimethyl-1,3-disilabutane and Methyldichlorosilane in the Presence of Benzyltributylphosphonium Chloride Catalyst

In the same manner as Example 1, 3.0 g (0.014 mol) of 1,1,1-trichloro-3,3-dimethyl-1,3-disilabutane, 9.7 g (0.084 mol) of methyldichlorosilane, and 0.5 g (0.0014 mol) of benzyltributylphosphonium chloride were put in a 25 ml stainless steel tube and reacted at 80° C. for three hours. The reactants were vacuum-distilled to obtain 2.1 g (yield: 80.1%) of 1,1-dichloro-3,3-dimethyl-1,3-disilabutane and 0.1 g (yield: 4.7%) of 1-chloro-3,3-dimethyl-1,3-disilabutane were obtained.

The results of analyzing the obtained products by using 300 MHz 1H magnetic resonance showed that, in 1,1-dichloro-3,3-dimethyl-1,3-disilabutane, Si—H peak was confirmed at δ5.57 ppm (t, 1H), —CH₂— peak was confirmed at δ1.30 ppm (d, 2H), and Si—CH₃ peak was confirmed at δ1.07 ppm (s, 9H). In 1-chloro-3,3-dimethyl-1,3-disilabutane, Si—H peak was confirmed at δ5.09 ppm (t, 2H), —CH₂— peak was confirmed at δ1.33 ppm (d, 2H), and Si—CH₃ peak was confirmed at δ1.13 ppm (s, 9H).

### Example 51

### Reaction of Vinyltrichlorosilane and 1,1,3,3-Tetrachloro-1,3-disilabutane in the Presence of Tetrabutylphosphonium Chloride Catalyst

In the same manner as Example 1, 1.0 g (0.006 mol) of vinyltrichlorosilane, 8.2 g (0.036 mol) of 1,1,3,3-tetrachloro-1,3-disilabutane, and 0.2 g (0.0006 mol) of tetrabutylphosphonium chloride were put in a 25 ml stainless steel tube and reacted at 90° C. for three hours. The reactants were atmospheric-distilled to obtain 0.6 g (yield: 78.7%) of vinyldichlorosilane and 0.1 g (yield: 18.0%) of vinylchlorosilane were obtained.

The results of analyzing the obtained products by using 300 MHz 1H magnetic resonance showed that, in vinyldichlorosilane, Si—H peak was confirmed at δ5.68 ppm (d, 1H), CH₂═CH—Si peak was confirmed at δ6.33 ppm (q, 1H), and CH₂═CH—Si peak was confirmed at δ5.34 ppm (d, 2H). In vinylchlorosilane, Si—H peak was confirmed at δ5.18 μm (d, 2H), CH₂═CH—Si peak was confirmed at δ6.23 ppm (m, 1H), and CH₂═CH—Si peak was confirmed at δ5.20 ppm (d, 2H).

### Example 52

### Reaction of Vinyltrichlorosilane and 1,1,3,3,3-Pentachloro-1,3-disilapropane in the Presence of Tetrabutylphosphonium Chloride Catalyst

In the same manner as Example 1, 1.0 g (0.006 mol) of vinyltrichlorosilane, 8.9 g (0.036 mol) of 1,1,3,3,3-pentachloro-1,3-disilapropane, and 0.2 g (0.0006 mol) of tetrabutylphosphonium chloride were put in a 25 ml stainless steel tube and reacted at 90° C. for three hours. The reactants were atmospheric-distilled to obtain 0.5 g (yield: 65.6%) of vinyldichlorosilane and 0.1 g (yield: 18.0%) of vinylchlorosilane were obtained. Peak confirmation of each product is the same as Example 51 above.

### Example 53

### Reaction of Hexachlorodisilane and Methyldichlorosilane in the Presence of a Solid Catalyst in which Tetrabutylphosphonium Chloride-immobilized Silicone Resin is coated onto Silica

In the same manner as Example 1, 4.0 g (0.015 mol) of hexachlorodisilane, 9.7 g (0.084 mol) of methyldichlorosilane, and a catalyst in which 1.0 g of solid silicone resin containing 0.4 g (0.0014 mol) of tetrabutylphosphonium chloride is coated onto 3.0 g of silica were put in a 25 ml stainless steel tube and reacted at 80° C. for two hours. The reactants were atmospheric-distilled to obtain 2.5 g (yield: 71.5%) of pentachlorodisilane and 0.37 g (yield: 12.5%) of tetrachlorodisilane were obtained.

The results of analyzing the obtained products by using 300 MHz 1H magnetic resonance showed that, in pentachlorodisilane, Si—H peak was confirmed at δ5.38 ppm (s, 1H). In 1,1,2,2-tetrachlorodisilane, Si—H peak was confirmed at δ4.92 ppm (d, 2H).

### Example 54

### Reaction of Hexachlorodisilane and Methyldichlorosilane in the Presence of a Solid Catalyst in which Tetrabutylphosphonium Chloride-immobilized Silicone Resin is Coated onto Bead-Shaped Activated Carbon

In the same manner as Example 1, 4.3 g (0.015 mol) of hexachlorodisilane, 9.7 g (0.084 mol) of methyldichlorosilane, and a solid catalyst in which 1.0 g of silicone resin containing 0.4 g (0.0014 mol) of tetrabutylphosphonium chloride is coated onto 3.0 g of bead-shaped activated carbon were put in a 25 ml stainless steel tube and reacted at 80° C. for four hours. The reactants were atmospheric-distilled to obtain 2.7 g (yield: 70.6%) of pentachlorodisiloxane and 0.5 g (yield: 15.5%) of tetrachlorodisiloxane were obtained.

The results of analyzing the obtained products by using 300 MHz 1H magnetic resonance showed that, in pentachlorodisiloxane, Si—H peak was confirmed at 55.78 ppm (s, 1H). In 1,1,2,2-tetrachlorodisiloxane, Si—H peak was confirmed at δ5.32 ppm (s, 2H).

1. An organic chlorohydrosilane represented by the following Chemical Formula 1:
R³—SiHₐCl₍₃₋ₐ₎ [Chemical Formula 1]
wherein a is 1 or 2,
when a is 1, R³ represents chlorine, a linear alkyl group having 2 to 18 carbons, isopropyl, isobutyl, cyclopentyl, cyclohexyl, neopentyl, 2-ethylhexyl, iso-octyl, cycloheptyl, cyclooctyl; cyclohexenylmethyl, 9-anthrathenyl, 9-anthrathenylmethyl, 2-(2-pyridyl)ethyl, 2-(4-pyridyl)ethyl, CF₃CH₂CH₂, diphenylmethyl, 2-(bicycloheptyl), 5-[(bicycloheptenyl)ethyl], 11-acetoxyundecyl, 11-chloroundecyl, phenyl, benzyl, 2-phenylethyl, 1-naphthyl, CH₃(C═O)O(CH₂)_{K} (here, k is 2, 3, 10), R⁴-Ph-(CH₂)ₗ (here, l is 0, 1, 2, 3 and R⁴ is an alkyl group having 1 to 4 carbons or a halogen atom), Cl—(CH₂)ₘ (here, m is an integer of 1 to 12), NC—(CH₂)ₙ (here, n is an integer of 2 to 11), CH₂═CH—(CH₂)ₒ (here, o is an integer of 0 to 20), Ar¹—CH(Me)—CH₂ (here, Ar¹ is an alkyl group having 1 to 4 carbons, phenyl substituted with a halogen atom, biphenyl, biphenyl ether or naphthyl), Ar²O—(CH₂)ₚ (here, p is an integer of 3 to 18 and Ar² is phenyl, biphenyl, biphenyl ether, naphthyl, or phenanthryl), Cl₃Si—(CH₂)_{q} (here, q is an integer of 0 to 12 and Cl₃Si may be Cl₂HSi), Cl₃Si—(CH₂)ᵣ—Ar³—(CH₂)ᵣ (here, r is 0 or 1, Ar³ is phenyl, biphenyl, naphthyl, or anthrathenyl, and Cl₃Si may be Cl₂HSi), or 2,2,5,5-tetrachloro-4-trichlorosilyl-2,5-disilylcyclohexyl (here, Cl₃Si may be Cl₂HSi); and
when a is 2, R³ is chlorine, a linear alkyl group having 2 to 18 carbons, isopropyl, isobutyl, 2-ethylhexyl, cyclopentyl, cyclohexyl, 2-(bicycloheptyl), neopentyl, iso-octyl, cycloheptyl, cyclooctyl, cyclohexenylmethyl, 2-(2-pyridyl)ethyl, 2-(4-pyridyl)ethyl, 5-[(bicycloheptenyl)ethyl], 11-acetoxyundecyl, 11-chloroundecyl, phenyl, benzyl, 2-phenylethyl, 1-naphthyl, naphthylmethyl, diphenylmethyl, CH₃(C═O)O(CH₂)_{K} (here, k is 2, 3, 10), R⁴-Ph-(CH₂)ₗ (here, l is 0, 1, 2, 3 and R⁴ is an alkyl group having 1 to 4 carbons or a halogen atom), Cl—(CH₂)ₘ (here, m is an integer of 1 to 12), NC—(CH₂)ₘ (here, m is an integer of 2 to 11), CH₂═CH—(CH₂)ₒ (here, o is an integer of 0 to 20), Ar¹-CH(Me)—CH₂ (here, Ar¹ is an alkyl group having 1 to 4 carbons, phenyl substituted with a halogen atom, biphenyl, biphenyl ether, or naphthyl), Ar²O—(CH₂)ₚ (here, p is an integer of 3 to 18 and Ar² is phenyl, biphenyl, biphenyl ether, naphthyl, or phenanthryl), or Ar⁴—(CH₂)_{q}— (here, q is 0 or 1 and Ar⁴ is biphenyl or anthrathenyl).

2. A method for preparing the organic chlorohydrosilane represented by Chemical Formula 1 according to claim 1 by reacting a silane compound represented by Chemical Formula 2 shown below and an organic chlorosilane represented by Chemical Formula 3 shown below in the presence of a quaternary organic phosphonium salt catalyst: 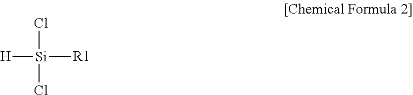
wherein R¹ is chorine, methyl, trichlorosilylmethyl, dichlorosilylmethyl, or methyldichlorosilylmethyl, and
R²—SiCl₃. [Chemical Formula 3]
wherein R² is chlorine, a linear alkyl group having 2 to 18 carbons, isopropyl, isobutyl, tertiary-butyl, neopentyl, iso-octyl, cyclopentyl, cyclohexyl, cycloheptyl, cyclooctyl, cyclohexenylmethyl, 2-(2-pyridyl)ethyl, 2-(4-pyridyl)ethyl, 2-(bicycloheptyl), 5-[(bicycloheptenyl)ethyl], 5-(bicycloheptenyl), 11-acetoxyundecyl, 11-chloroundecyl, phenyl, benzyl, 2-phenylethyl, 1-naphthyl, diphenylmethyl, CH₃(C═O)O(CH₂)_{K} (here, k is 2, 3, 10), CF₃(CF₂)ₗCH₂CH₂— (here, l is an integer of 0 to 12), R⁴-Ph-(CH₂)ₘ (here, m is 0, 1, 2, 3 and R⁴ is an alkyl group having 1 to 4 carbons or a halogen atom), Cl—(CH₂)ₙ— (here, n is an integer of 1 to 12), NC—(CH₂)ₒ— (here, o is an integer of 2 to 11), CH₂═CH—(CH₂)ₚ (here, p is an integer of 0 to 20), Ar¹-CH(Me)—CH₂— (here, Ar¹ is an alkyl group having 1 to 4 carbons, phenyl substituted with a halogen atom, biphenyl, biphenyl ether, or naphthyl), Ar²O—(CH₂)_{q} (here, q is an integer of 3 to 18 and Ar² is phenyl, biphenyl, biphenyl ether, naphthyl, or phenanthryl), Cl₃Si—(CH₂)ᵣ (here, r is an integer of 0 to 12), Cl₃Si—(CH₂)ₛ—Ar³—(CH₂)ₛ (here, s is 0 or 1, Ar³ is phenyl, biphenyl, naphthyl, anthrathenyl, or 2,2,5,5-tetrachloro-4-trichlorosilyl-2,5-disilylcyclohexyl), or Ar⁴—(CH₂)ₜ (here, t is 0 or 1 and Ar⁴ is phenyl, biphenyl, naphthyl, or anthrathenyl), trichlorosilyl(Cl₃Si—) or trichlorosilyloxy (Cl₃SiO).

3. The method of claim 2, wherein the quaternary organic phosphonium salt catalyst is represented by Chemical Formula 4 or 5 shown below:
X(R⁵)₄P [Chemical Formula 4]
X(R⁵)₃P—Y—P(R⁵)₃X [Chemical Formula 5]
wherein X indicates a halogen atom, R⁵, which is the same or different, indicates an alkyl group having 1 to 12 carbons or —(CH₂)ᵤ—C₆H₅ (here, u is an integer of 0 to 6), two R⁵s can be covalently bonded to form 4-atom rings or 8-atom rings, and Y is an alkylene group having 1 to 12 carbons.

4. The method of claim 2, wherein the quaternary organic phosphonium salt catalyst is contained within the range of from about 0.05 mol to about 0.5 mol with respect to 1 mol of the organic chlorosilane represented by Chemical Formula 3.

5. The method of claim 2, wherein the quaternary organic phosphonium salt catalyst has a structure of being immobilized on one or more carriers selected from the group consisting of a silicone resin, silica, an inorganic complexing agent, and an organic polymer.

6. The method of claim 2, wherein the silane compound represented by Chemical Formula 2 is reacted within the range of from about 1 to about 20 mol with respect to 1 mol of the organic chlorosilane represented by Chemical Formula 3.

7. The method of claim 2, wherein the reaction is performed within a temperature range of from about 20 to about 200° C.

8. The method of claim 2, wherein the reaction is performed without a reaction solvent or in the presence of an aromatic hydrocarbon solvent.

9. The method of claim 2, the reaction is performed in a batch process or a continuous process.
